(19) United States
(12) Patent Application Publication
(10) Pub. No.: US 2016/0179401 A1
(43) Pub. Date: Jun. 23, 2016

(54) MEMORY SYSTEM AND THE OPERATION METHOD THEREOF

(71) Applicant: SK hynix memory solutions inc., San Jose, CA (US)

(72) Inventors: Fan ZHANG, Fremont, CA (US); David J. PIGNATELLI, Saratoga, CA (US); Yu Chin Fabian LIM, Cupertino, CA (US)

(21) Appl. No.: 14/964,168

(22) Filed: Dec. 9, 2015

Related U.S. Application Data
(60) Provisional application No. 62/093,367, filed on Dec. 17, 2014.

(51) Int. Cl. G06F 3/06

(52) U.S. Cl. CPC G06F 3/0608; G06F 3/064; G06F 3/0653; G06F 3/0658; G06F 3/0679

(57) ABSTRACT

A system includes a memory device including a plurality of blocks and a controller suitable for controlling the memory device. The controller creates a k-dimensional array from the plurality of the blocks, where k is greater than 2, and selects best candidate blocks from the k-dimensional array with respect to the k metrics. The k-dimensional array includes 2-dimensional linked list arrays.

### CROSS-REFERENCE TO RELATED APPLICATIONS

This application claims the benefit of U.S. Provisional Application No. 62/093,367, filed Dec. 17, 2014, the entire contents of which are incorporated herein by reference.

### BACKGROUND

1. Field

Exemplary embodiments of the present disclosure relate to a memory system and the operation method thereof.

2. Description of the Related Art

Non-volatile storage mediums such as flash memory are increasingly gaining applications in both enterprise and consumer data storage solutions. The flash memories are resilient to shock, and their input/output (I/O) performance is better than that of conventional hard disk drives. Also, in contrast to the conventional hard disk drives, the flash memories are small in size and consume little power. However, due to the limited storage space, an improvement of memory management is needed.

### SUMMARY

Embodiments of the present disclosure are directed to a memory system including a memory device and a method for operating the memory device.

In accordance with an embodiment of the present invention, a system includes a memory device including a plurality of blocks and a controller suitable for controlling the memory device. The controller creates a k-dimensional array from the plurality of the blocks, where k is greater than 2, and selects best candidate blocks from the k-dimensional array with respect to the k metrics. The k-dimensional array includes 2-dimensional linked list arrays.

In accordance with another embodiment of the present invention, a method includes creating a k-dimensional array from a plurality of the blocks of a memory device each of the blocks having k metrics, where k is greater than 2, and selecting best candidate blocks from the k-dimensional array with respect to the k metrics. The k-dimensional array includes 2-dimensional linked list arrays.

### BRIEF DESCRIPTION OF THE DRAWINGS

FIG. 1 is a diagram of a data processing system including a memory system in which embodiments of the present invention are applied.

FIG. 2 is block diagram of a memory system in accordance with embodiments of the present invention.

FIG. 3 is a flowchart illustrating a process performed by a memory system in accordance with embodiments of the present invention.

FIGS. 4A and 4B are diagrams illustrating a k-D array in accordance with embodiments of the present invention.

FIG. 5 is a flowchart illustrating an operation for generating a k-D array in accordance with embodiments of the present invention.

FIG. 6 is a diagram illustrating an example of super blocks in accordance with embodiments of the present invention.

FIG. 7 is a diagram illustrating an example of generating a k-D array in accordance with embodiments of the present invention.

FIG. 8A is a flowchart illustrating an insertion operation in accordance with embodiments of the present invention.

FIG. 8B is a flowchart illustrating a deletion operation in accordance with embodiments of the present invention.

### DETAILED DESCRIPTION

Various embodiments will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the tasks As used herein, the term ‘processor’ refers to one or more devices, circuits, and/or processing cores configured to process data, such as computer program instructions.

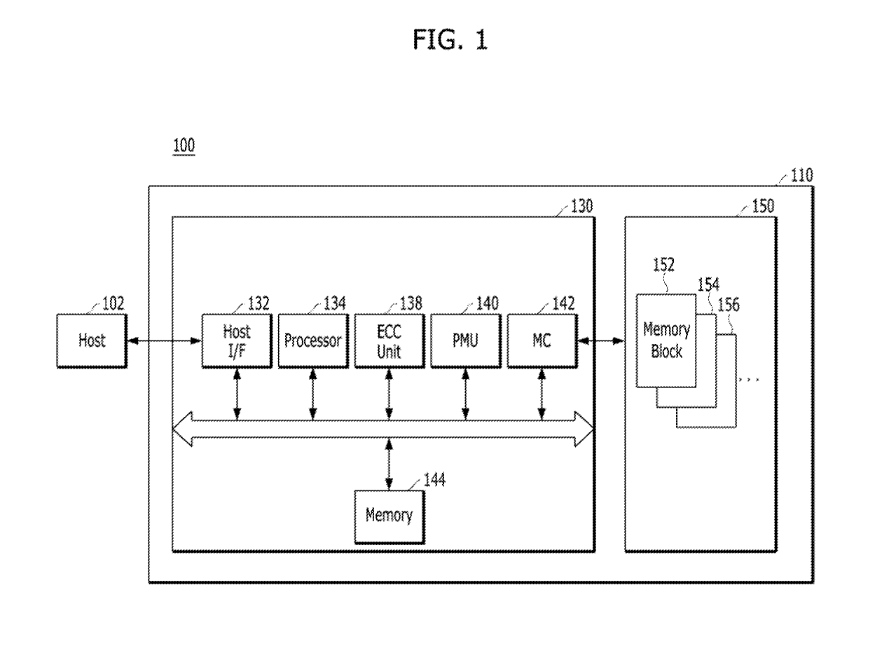

FIG. 1 illustrates a data processing system 100 including a memory system in which embodiments of the present invention are applied. The data processing system 100 shown in FIG. 1 is for illustration only. Other constructions of the data processing system 100 could be used without departing from the scope of the present invention. Although FIG. 1 illustrates one example of the data processing system 100, various changes may be made to FIG. 1. For example, the data processing system 100 may include any of elements, or may not include any of elements in any suitable arrangement.

Referring to FIG. 1, the data processing system 100 may include a host 102 and a memory system 110.

The host 102 may include, for example, a portable electronic device such as a mobile phone, an MP3 player and a laptop computer or an electronic device such as a desktop computer, a game player, a TV and a projector.

The memory system 110 may operate in response to a request from the host 102, and in particular, store data to be accessed by the host 102. In other words, the memory system 110 may be used as a main memory system or an auxiliary memory system of the host 102. The memory system 110 may be implemented with any one of various kinds of storage devices, according to the protocol of a host interface to be electrically coupled with the host 102. The memory system 110 may be implemented with any one of various kinds of storage devices such as a solid state drive (SSD), a multimedia card (MMC), an embedded MMC (eMMC), a reduced size MMC (RS-MMC) and a micro-MMC, a secure digital (SD) card, a mini-SD and a micro-SD, universal serial bus (USB) storage device, a universal flash storage (UFS) device, a compact clash (CF) card, a smart media (SM) card, a memory stick, and so forth.

The storage devices for the memory system 110 may be implemented with a volatile memory device such as a dynamic random access memory (DRAM) and a static random access memory (SRAM) or a non-volatile memory device such as a read only memory (ROM), a mask ROM (MROM), a programmable ROM (PROM), an erasable programmable ROM (EPROM), an electrically erasable programmable ROM (EEPROM), a ferroelectric random access memory (FRAM) a phase change RAM (PRAM), a magnetoresistive RAM (MRAM) and a resistive RAM (RRAM).

The memory system 110 may include a memory device 150 which stores data to be accessed by the host 102, and a controller 130 which controls storage of data in the memory device 150.

The controller 130 and the memory device 150 may be integrated into one semiconductor device. For instance, the controller 130 and the memory device 150 may be integrated into one semiconductor device and configure a solid state drive (SSD). When the memory system 110 is used as the SSD, the operation speed of the host 102 that is electrically coupled with the memory system 110 may be significantly increased.

The controller 130 and the memory device 150 may be integrated into one semiconductor device and configure a memory card. The controller 130 and the memory device 150 may be integrated into one semiconductor device and configure a memory card such as a Personal Computer Memory Card International Association (PCMCIA) card, a compact flash (CF) card, a smart media (SM) card (SMC), a memory stick, a multimedia card (MMC), an RS-MMC and a micro-MMC, a secure digital (SD) card, a mini-SD, a micro-SD and an SDHC, and a universal flash storage (UFS) device.

For another instance, the memory system 110 may configure a computer, an ultra mobile PC (UMPC), a workstation, a net-book, a personal digital assistant (PDA), a portable computer, a web tablet, a tablet computer, a wireless phone, a mobile phone, a smart phone, an e-book, a portable multimedia player (PMP), a portable game player, a navigation device, a black box, a digital camera, a digital multimedia broadcasting (DMB) player, a three-dimensional (3D) television, a smart television, a digital audio recorder, a digital audio player, a digital picture recorder, a digital picture player, a digital video recorder, a digital video player a storage configuring a data center, a device capable of transmitting and receiving information under a wireless environment, one of various electronic devices configuring a home network, one of various electronic devices configuring a computer network, one of various electronic devices configuring a telematics network, an RFID device, or one of various component elements configuring a computing system.

The memory device 150 of the memory system 110 may retain stored data when power supply is interrupted and, in particular, store the data provided from the host 102 during a write operation, and provide stored data to the host 102 during a read operation. The memory device 150 may include a plurality of memory blocks 152, 154 and 156. Each of the memory blocks 152, 154 and 156 may include a plurality of pages. Each of the pages may include a plurality of memory cells to which a plurality of word lines (WL) are electrically coupled. The memory device 150 may be a non-volatile memory device, for example, a flash memory. The flash memory may have a three-dimensional (3D) stack structure.

The controller 130 of the memory system 110 may control the memory device 150 in response to a request from the host 102. The controller 130 may provide the data read from the memory device 150, to the host 102, and store the data provided from the host 102 into the memory device 150. To this end, the controller 130 may control overall operations of the memory device 150, such as read, write, program and erase operations.

In detail, the controller 130 may include a host interface unit 132, a processor 134, an error correction code (ECC) unit 138, a power management unit (PMU) 140, a memory controller (MC) 142, and a memory 144.

The host interface unit 132 may process commands and data provided from the host 102, and may communicate with the host 102 through at least one of various interface protocols such as universal serial bus (USB), multimedia card (MMC), peripheral component interconnect-express (PCI-E), serial attached SCSI (SAS), serial advanced technology attachment (SATA), parallel advanced technology attachment (PATA), small computer system interface (SCSI), enhanced small disk interface (ESDI), and integrated drive electronics (IDE).

The ECC unit 138 may detect and correct errors in the data read from the memory device 150 during the read operation. The ECC unit 138 may not correct error bits when the number of the error bits is greater than or equal to a threshold number of correctable error bits, and may output an error correction fail signal indicating failure in correcting the error bits.

The ECC unit 138 may perform an error correction operation based on a coded modulation such as a low density parity check (LDPC) code, a Bose-Chaudhuri-Hocquenghem (BCH) code, a turbo code, a turbo product code (TPC), a Reed-Solomon (RS) code, a convolution code, a recursive systematic code (RSC), a trellis-coded modulation (TCM), a Block coded modulation (BCM), and so on. The ECC unit 138 may include all circuits, systems or devices for the error correction operation.

The PMU 140 may provide and manage power for the controller 30, that is, power for the component elements included in the controller 130.

The MC 142 may serve as a memory interface between the controller 130 and the memory device 150 to allow the controller 130 to control the memory device 150 in response to a request from the host 102. The MC 142 may generate control signals for the memory device 150 and process data under the control of the processor 134. When the memory device 150 is a flash memory such as a NAND flash memory, the MC 142 may generate control signals for the NAND flash memory 150 and process data under the control of the processor 134.

The memory 144 may serve as a working memory of the memory system 110 and the controller 130, and store data for driving the memory system 110 and the controller 130. The controller 130 may control the memory device 150 in response to a request from the host 102. For example, the controller 130 may provide the data read from the memory device 150 to the host 102 and store the data provided from the host 102 in the memory device 150. When the controller 130 controls the operations of the memory device 150 the memory 144 may store data used by the controller 130 and the memory device 150 for such operations as read, write, program and erase operations.

The memory 144 may be implemented with volatile memory. The memory 144 may be implemented with a static random access memory (SRAM) or a dynamic random access memory (DRAM). As described above, the memory 144 may store data used by the host 102 and the memory device 150 for the read and write operations. To store the data, the memory 144 may include a program memory, a data memory, a write buffer, a read buffer, map buffer, and so forth.

The processor 134 may control general operations of the memory system 110, and a write operation or a read operation for the memory device 150, in response to a write request or a read request from the host 102. The processor 134 may drive firmware, which is referred to as a flash translation layer (FTL), to control the general operations of the memory system 110. The processor 134 may be implemented with a microprocessor or a central processing unit (CPU).

A management unit (not shown) may be included in the processor 134, and may perform bad block management of the memory device 150. The management unit may find bad memory blocks included in the memory device 150, which are in unsatisfactory condition for further use, and perform had block management on the bad memory blocks. When the memory device 150 is a flash memory, for example, a NAND flash memory, a program failure may occur during the write operation, for example, during the program operation, due to characteristics of a NAND logic function. During the bad block management, the data of the program-failed memory block or the bad memory block may be programmed into a new memory block. Also, the bad blocks due to the program fail seriously deteriorates the utilization efficiency of the memory device 150 having a 3D stack structure and the reliability of the memory system 110, and thus reliable bad block management is required.

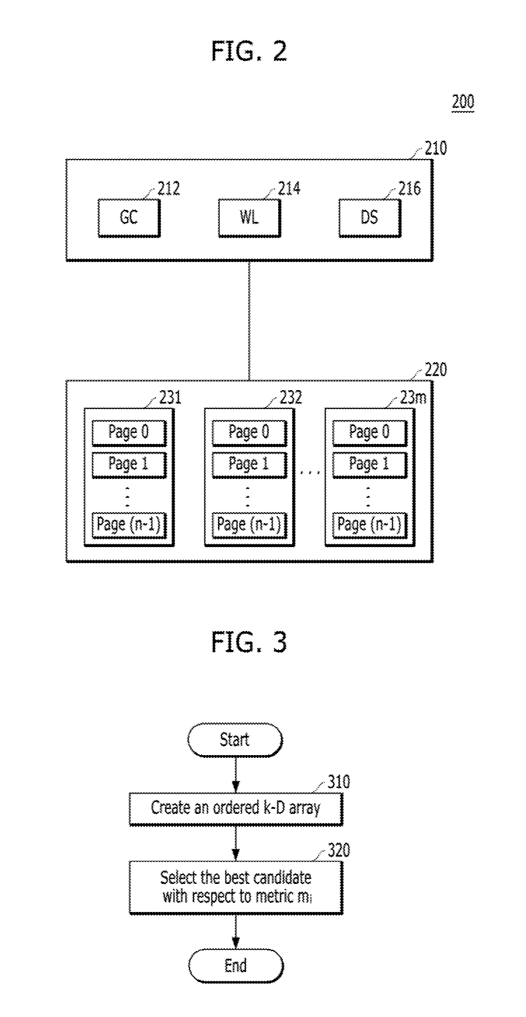

FIG. 2 is a block diagram of a memory system 200 in accordance with embodiments of the present invention. The embodiment of the memory system 200 shown in FIG. 2 is for illustration only. Other embodiments of the memory system could be used without departing from the scope of the present invention.

Referring to FIG. 2, the memory system 200 includes a memory controller 210 and a memory device 220. For example, the memory controller 210 and the memory device 220 correspond to the processor 134 and the memory device 150 shown in FIG. 1, respectively. In some embodiments, the memory device 220 may include a NAND flash memory. In some embodiments, the memory controller 210 may be a semiconductor device such as an application-specific integrated circuit (ASIC) or a field-programmable gate array (FPGA).

The memory device 220 as the NAND flash memory includes a plurality of memory blocks 231, 232 . . . 23m. Each of the memory blocks 231, 232 . . . 23m includes a plurality of pages Page 0, Page 1 . . . Page (n-1).

The memory controller 210 controls various operations (e.g., write, read, program, erase) for the memory device 220 In particular, the memory controller 210 controls firmware algorithms for a flash translation layer (FTL). For example, the memory controller 210 includes a garbage collection (GC) module 212, a wear leveling (WL) module 214 and a hot-cold data separation (DS) module 216.

In the NAND flash memory controllers, a certain number of physical blocks are organized into a super block. Each super block has several metrics associated with it. For example, several metrics include program-erase (PE) counts, number of valid pages, and sequence numbers. The garbage collection (GC), wear-leveling (WL) and hot-cold data separation (DS) are all based on super blocks. By the current NAND technology, the size of a super block grows linearly with the capacity of the memory system such as a solid state drive (SSD). The memory consumed by the existing firmware grows linearly with the size of a super block. As a result, the firmware size scales linearly with the capacity of the drive.

It may be decided to make the firmware size of the memory system stay constant or grow sub-linearly with the capacity of the drive. To achieve this, the size of a super block is to be constant and the number of super blocks is to be grown linearly with the capacity of the drive. As a result, the number of super blocks may grow from thousands to millions depending on configuration.

The GC, WL and DS often require finding the super block with a minimum PE counts, a minimum number of valid pages or sequence number near some value. Keeping track of many sorted arrays may be too memory costly since the number of super blocks increases. Going through the entire super block list multiple times to find the best candidates under different metrics is time consuming. Thus, it is desirable to develop a data structure and an algorithm which only require a single copy of the super list and provide the best candidate under all metrics in sub-linear (with respect to the number of super blocks) time.

In one operation, selection of the best candidates with respect to a certain metric (e.g., number of valid pages, PE counts, etc.) in a long list of blocks is performed. In another operation, selection of the best (with respect to the number of valid pages) candidate within a certain range of a given block temperature is performed (e.g., conditional selection).

In some designs for the above mentioned operations, the entire super-block lists are scanned through multiple times to find the best candidates and conditionally best candidate. However, this is not practical due to the increasing number of super blocks. Other designs are sub-optimally implemented in firmware. For example, instead of scanning through all the super blocks, a small portion of the super blocks is scanned from time to time, which provides a shorter search time. However, there is no guarantee that the optimal super block can be found with this approach.

Thus, disclosed herein is an algorithm that guarantees to find the optimal super block in sub-linear time.

FIG. 3 is a flowchart illustrating a process performed by a memory system in accordance with embodiments of the present invention. The embodiment of the process shown in FIG. 3 is for illustration only. Other embodiments of the process could be used without departing from the scope of the present invention. For example, the process shown in FIG. 3 will be performed by the controller 210 shown in FIG. 2.

Referring to FIG. 3, at block 310, an ordered k-dimensional (D) array is created from a plurality of blocks. For example, the controller 210 may create an ordered k-dimensional (D) array from the plurality of blocks 231, 232 . . . 23m of the memory device 220 shown in FIG. 2.

In some embodiments, the blocks may be super blocks, each of which are organized by a certain number of physical blocks of the memory device 220. All the blocks may be organized into the k-dimensional array, where k is greater than 2. The number of dimensions may be equal to the number of metrics of the memory device 220.

In some embodiments, the k-dimensional array may be, but not limited to, a 3-dimensional array by using a linked list. The 3-dimensional array corresponds to 3 metrics such as program-erase (PE) counts, the number of valid pages and sequence numbers. The 3-dimensional array may include 2-dimensional linked list arrays. Each of the 2-dimensional arrays includes a first dimension and a second dimension. The first dimension has strong ordering on a first metric of the k metrics and the second dimension has weak ordering on a second metric of the k metrics. In the k-dimensional array, there is one dimension with strong ordering and all other dimensions with weak ordering. There are duplicated metric values in the block list. Such ordered array is called as an ordered k-D array.

At block 320, the best candidate block is selected with respect to a metric mᵢ. In an embodiment, the controller 210 selects best candidate blocks from the k-dimensional array with respect to the k metrics mᵢ. In some embodiments, the controller 210 finds the best candidate with respect to m₂ and the conditional best candidate with respect to m₂ around a certain value of m₁ based on the selection and conditional selection algorithms as follows:

Selection: To select the best (assuming smaller metric the better) candidate with respect to metric mᵢ the controller 210 goes through the subset of blocks with coordinate [x₁, x₂, . . . , xᵢ₋₁, xᵢ, xᵢ₊₁, . . . xₖ] to find the best candidate.

Conditional selection: Consider the block array has strong ordering in x₁. A slice of x₁=a may be defined as a subset of blocks with coordinates [a, x₂, . . . xₖ]. The controller 210 first identifies the slice which contains the value m₁=b. The blocks within the same slice of the block with m₁=b should have their m₁ around b due to the strong ordering property. A local search may then be conducted in the slice and its neighboring slices if needed.

The data structure and the strong order property allow finding of the blocks which have similar values of m₁ without scanning through all the blocks or keeping another copy of the block list in the order of m₁.

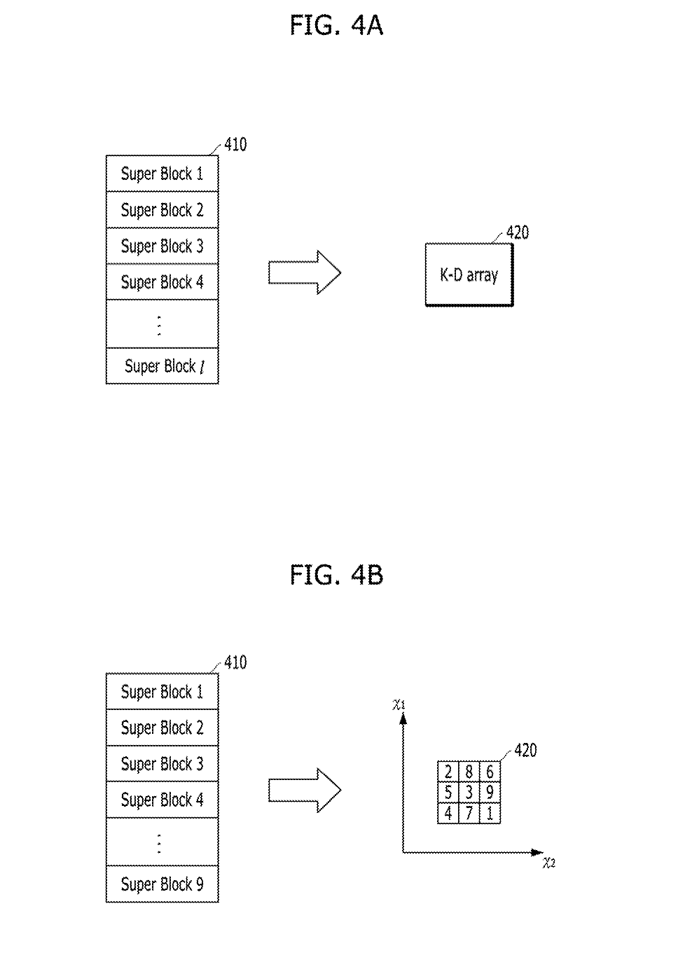

FIG. 4A and 4B are diagrams illustrating a k-dimensional (D) array 420 in accordance with embodiments of the present invention. The embodiment of the k-dimensional array 420 shown in FIG. 4A and FIG. 4B is for illustration only. Other embodiments of the k-dimensional array could be used without departing from the scope of the present invention.

Referring to FIG. 4A, all the super blocks 410 are organized to the k-dimensional array 420. In some embodiments, the k-dimensional array 420 may be a 3-dimensional array by using a linked list.

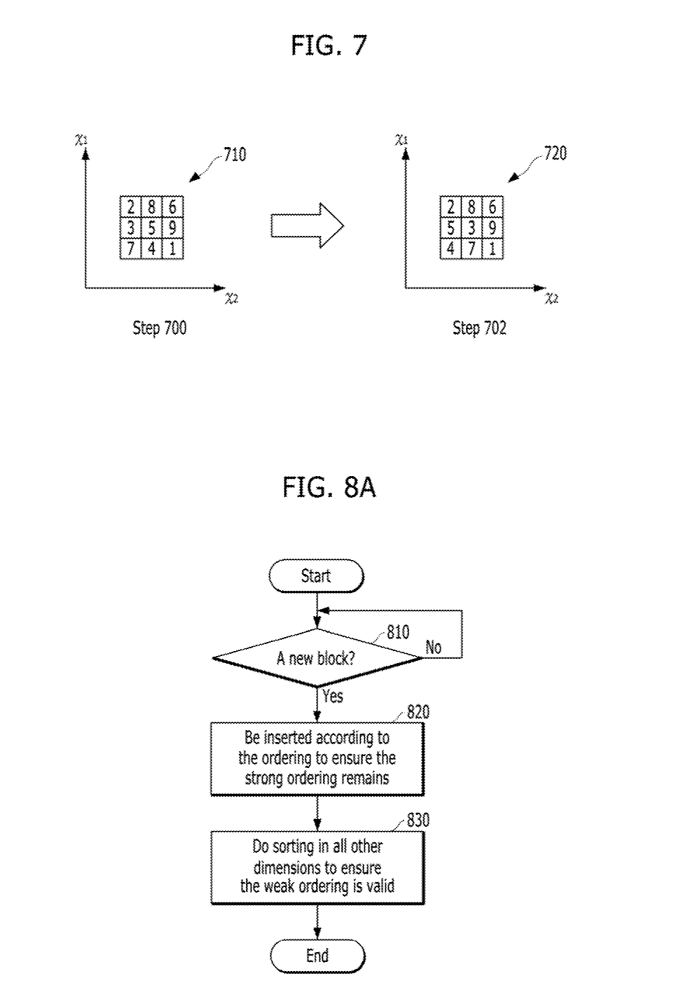

Referring to FIG. 4B, 9 super blocks 410 are organized to the 3-dimensional array. Although an ordered 2-dimensional linked list array 420 is shown, other dimensional linked list arrays may be utilized. The 2-dimensional array 420 includes a first dimension x₁ and a second dimension x₂. The generation of the 2-dimensional array 420 will be detailed below with reference to FIG. 6 and FIG. 7.

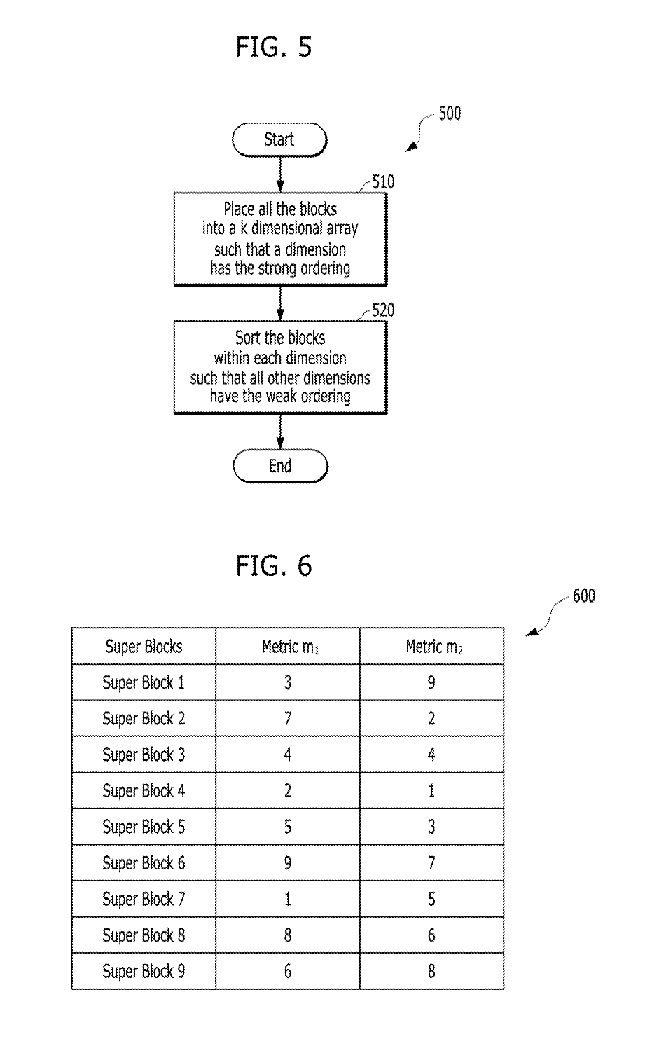

FIG. 5 is a flowchart illustrating an operation 500 for generating a k-dimensional (D) array in accordance with embodiments of the present invention. The embodiment of the operation 500 shown in FIG. 5 is for illustration only. Other embodiments of the operation could be used without departing from the scope of the present invention. The following steps can be used to construct such an ordered k-D array. The operation 500 may be performed by the controller 210 in FIG. 2.

Referring to FIG. 5, at block 510, all the blocks are placed into a k-dimensional array such that there is 1 dimension with the strong ordering For example, the dimensions x₁ of FIG. 4B has strong ordering. In an embodiment, according to m₁ values, the controller 210 places all blocks into a k-D array in the order of coordinate x₁, x₂, . . . , xₖ. This guarantees the strong ordering in dimension x₁.

At block 520, the blocks are sorted such that all other dimensions have the weak ordering. For example, the dimension x₂ of FIG. 4B has weak ordering. In an embodiment, the controller 210 sorts the blocks within each dimension by fixing the coordinates of all other dimensions. Step 2 will guarantee the weak ordering in all other dimensions. The statement is still true when there are duplicated metric values in the block list.

It is always assumed that the system state starts from an ordered k-D array, because the initial value of all metrics will be reset to the same values.

FIG. 6 is a diagram illustrating an example of super blocks 600 in accordance with embodiments of the present invention. The embodiment of the super blocks 500 shown in FIG. 6 is for illustration only. Other embodiments of the super blocks could be used without departing from the scope of the present invention.

Referring to FIG. 6, there are 9 super blocks, labeled from 1 to 9. Each block has metrics m₁ and m₂. It is assumed that the metric m₁=[3, 7, 4, 2, 5, 9, 1, 8, 6] and the second metric m₂=[9, 2, 4, 1, 3, 7, 5, 6, 8].

FIG. 7 is a diagram illustrating generation of a k-dimensional (D) array in accordance with embodiments of the present invention. The embodiment of the k-dimensional array shown in FIG. 7 is for illustration only. Other embodiments of the memory system could be used without departing from the scope of the present invention.

Referring to FIG. 7, nine super blocks (e.g., super blocks 600 of FIG. 6) are organized into a 2D array 720 such that the block array 720 has strong ordering on m₁ in x₁ dimension and weak ordering on m₂ in x₂ dimension.

At step 700, 9 super blocks 600 of FIG. 6 is placed into a k-D array 710 in the order of coordinates x₁, x₂, . . . , xₖ. Step 700 will guarantee the strong ordering in dimension x₁. An array be defined as the array with strong ordering on m₁, if and only if all the blocks with x₁ coordinates larger than a have m₁ metrics larger than the m₁ metrics of all blocks with x₁ coordinates no less than a. For example, the m₁ metric of block 4 is 2 and it is less than the m₁ metrics of blocks 5, 3, 9, 2, 8, and 6, because they all have x₁ coordinates larger than block 7's x₁ coordinate.

At step 702, the blocks within each dimension are sorted by fixing the coordinates of all other dimensions. Step 702 will guarantee the weak ordering in all other dimensions. An array will be defined as the array with weak ordering on m₂, if and only if the ordering is true within the subset of blocks such that all the coordinates except for x₂ are fixed. For example, block 5 has m₂ metric 3, which is less than the m₂ metrics of block 3 and 9, block 4 has an m₂ less than blocks 7 and 1 and block 2 has an m₂ metric less than blocks 8 and 6. Due to the weak ordering property, we note that the relationship between the m₂ values of blocks 2 and 3 may not be defined.

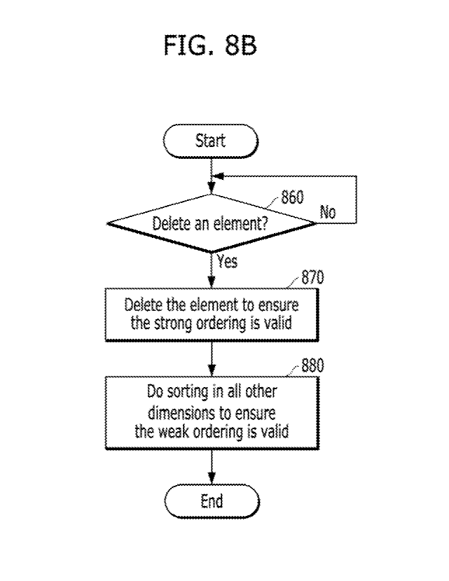

FIG. 8A is a flowchart illustrating an insertion operation in accordance with embodiments of the present invention. The embodiment of the insertion operation shown in FIG. 8A is for illustration only. Other embodiments of the insertion operation could be used without departing from the scope of the present invention. The insertion operation may be performed by the controller 210 in FIG. 2.

Referring to FIG. 8A, at step 810, it is determined whether a new block is coming. If so, it is necessary to insert it into the ordered k-D array such that it remains ordered. For example, a new block with [m₁, m₂, . . . , mₖ] may be coming.

At step 820, the new block is inserted according to the ordering to ensure the strong ordering remains. For example, the controller 210 may insert the new block according to the ordering of m₁ to ensure the strong ordering in x₁ remains true. Step 820 is similar to step 700 in the array construction algorithm.

At step 830, all other dimensions are sorted to ensure weak ordering is valid. For example, the controller 210 does sorting in all other dimensions to ensure the weak ordering is still valid.

FIG. 8B is a flowchart illustrating a deletion operation in accordance with embodiments of the present invention. The embodiment of the deletion operation shown in FIG. 8B is for illustration only. Other embodiments of the deletion operation could be used without departing from the scope of the present invention. The deletion operation may be performed by the controller 210 in FIG. 2.

Referring to FIG. 8B, in the same way as the insertion operation of FIG. 8A, the deletion operation also has to keep the array ordered. At step 860, it is determined whether an element needs to be deleted.

At step 870, when it is determined that there is an element to be deleted, the element is deleted to ensure the strong ordering is valid. For example, the controller 210 may delete the element in the m₁ order to ensure the strong ordering is still valid.

At step 880, all other dimensions are sorted to ensure the weak ordering is valid. For example, the controller 210 may sort in all other dimension to satisfy the weak ordering of other dimensions. Embodiments of the present invention only need a single copy of the block list by way of a k-dimensional array by using linked list. It allows to select the best candidates in

$$𝒪 ( {n }^{\frac{k - 1}{k}} )$$

time complexity and select the conditional best candidate in

$$𝒪 ( {n }^{\frac{1}{k}} )$$

time complexity. The insertion and deletion complexity is [symbol] (n), where n is the number of blocks.

While the present invention has been particularly shown and described with reference to exemplary embodiments thereof, it will be understood by those of ordinary skill in the art that various changes in form and details may be made therein without departing from the spirit and scope of the present invention as defined by the following claims. Thus, the foregoing is by way of example only and is not intended to be limiting. For example, any numbers of elements illustrated and described herein are by way of example only. The present invention is limited only as defined in the following claims and equivalents thereof.

What is claimed is:

1. A system comprising:
a memory device including a plurality of blocks, each of the blocks having k metrics; and
a controller suitable for controlling the memory device,
wherein the controller is suitable for:
creating a k-dimensional array from the plurality of the blocks, where k is greater than 2; and
selecting best candidate blocks from the k-dimensional array with respect to the k metrics,
wherein the k-dimensional array includes 2-dimensional linked list arrays.

2. The system of claim 1, wherein each of the 2-dimensional arrays includes a first dimension and a second dimension, and
the controller is further suitable for placing and sorting the plurality of blocks such that the first dimension has strong ordering on a first metric of the k metrics and the second dimension has weak ordering on a second metric of the k metrics.

3. The system of claim 2, wherein the controller creates the k-dimensional array by:
placing the blocks into the k-dimensional array according to the first metric; and
sorting the blocks within each of the dimensions.

4. The system of claim 3, wherein the controller places the blocks into the k-dimensional array according to the first metric in the order of coordinates of the first dimension and the second dimension.

5. The system of claim 3, wherein the controller sorts the blocks within each of the dimensions by fixing coordinates of other dimensions.

6. The system of claim 2, wherein the controller is suitable for selecting a best candidate block with respect to the second metric by going through a subset of blocks with coordinates of the first dimension and the second dimension with respect to the second metric.

7. The system of claim 2, wherein the controller is further suitable for selecting a conditional best candidate block with respect to the second metric around a certain value of the first metric.

8. The system of claim 2, wherein the controller is further suitable for inserting a new block into the k-dimensional array such that the k-dimensional array remains ordered.

9. The system of claim 2, wherein the controller is further suitable for deleting a certain block in the k-dimensional array such that the k-dimensional array remains ordered.

10. The system of claim 1, wherein the k metrics include at least one of program-erase (PE) counts, the number of valid pages and sequence numbers.

11. A method comprising:
creating a k-dimensional array from a plurality of the blocks of a memory device, each of the blocks having k metrics, where k is greater than 2; and
selecting best candidate blocks from the k-dimensional array with respect to the k metrics,
wherein the k-dimensional array includes 2-dimensional linked list arrays.

12. The method of claim 11, wherein each of the 2-dimensional arrays includes a first dimension and a second dimension, and
the method further includes placing and sorting the plurality of blocks such that the first dimension has strong ordering on a first metric of the k metrics and the second dimension has weak ordering on a second metric of the k metrics.

13. The method of claim 12, wherein the creating of the k-dimensional array from the plurality of the blocks comprises:
placing the blocks into the k-dimensional array according to the first metric; and
sorting the blocks within each of the dimensions.

14. The method of claim 13, wherein the placing of the blocks into the k-dimensional array comprises:
placing the blocks into the k-dimensional array according to the first metric in the order of coordinates of the first dimension and the second dimension.

15. The method of claim 13, wherein the sorting of the blocks comprises:
sorting the blocks within each of the dimensions by fixing coordinates of other dimension.

16. The method of claim 12, wherein the selecting of the best candidate blocks comprises:
selecting a best candidate block with respect to the second metric by going through a subset of blocks with coordinates of the first dimension and the second dimension with respect to the second metric.

17. The method of claim 12, further comprising:
selecting a conditional best candidate block with respect to the second metric around a certain value of the first metric.

18. The method of claim 12, further comprising:
inserting a new block into the k-dimensional array such that the k-dimensional array remains ordered.

19. The method of claim 12, further comprising:
deleting a certain block in the k-dimensional array such that the k-dimensional array remains ordered.

20. The method of claim 11, wherein the k metrics include at least one of program-erase (PE) counts, the number of valid pages and sequence numbers.
